(19) United States
(12) Patent Application Publication
(10) Pub. No.: US 2017/0116671 A1
(43) Pub. Date: Apr. 27, 2017

(54) METHOD OF LEVERAGING CERTAIN BUSINESS ENTITIES AS REAL ESTATE INVESTMENT TRUSTS (REITS)

(71) Applicant: Vince CLARK, Westfield, NJ (US)

(72) Inventor: Vince CLARK, Westfield, NJ (US)

(21) Appl. No.: 14/925,412

(22) Filed: Oct. 28, 2015

Related U.S. Application Data
(63) Continuation of application No. 14/920,382, filed on Oct. 22, 2015, now abandoned.

(51) Int. Cl. G06Q 40/06; G06Q 40/04

(52) U.S. Cl. CPC G06Q 40/06; G06Q 40/04

(57) ABSTRACT

A method for leveraging certain business entities as real estate investment trusts. Such a method may include creating at least one operating partnership associated with a REIT; placing at least one business entity into the at least one operating partnership; transferring a plurality of operating partnership units associated with the at least one operating partnership to the owner of the at least one business entity; engaging in a transaction whereby a plurality of operating partnership units associated with the at least one operating partnership are exchanged for a plurality of shares in the REIT; and selling a plurality of the exchanged plurality of the shares in the REIT to the public.

### INCORPORATION BY REFERENCE

This application is a continuation of U.S. patent application No. 14/920,382, filed Oct. 22, 2015, the entire contents of which are hereby incorporated by reference.

### BACKGROUND

A REIT, or Real Estate Investment Trust, is a company that owns or finances income-producing real estate. Modeled after mutual funds, REITs provide investors of all types regular income streams, diversification and long-term capital appreciation. REITs typically pay out all or most of their taxable income as dividends to shareholders; for example, in the United States, they may be required to pay at least 90% of their income to shareholders in this way. In turn, shareholders pay the income taxes on those dividends.

REITs were created in order to give all investors the opportunity to invest in large-scale income-producing real estate. As such, REITs allow small investors or other investors to invest in large single assets or portfolios of large-scale properties the same way they invest in other industries: through the purchase of stock. In the same way shareholders benefit by owning stocks in other corporations, the stockholders of a REIT earn a share of the income produced through real estate investment, without actually having to go out and buy or finance property.

REITs may also offer certain benefits to real estate owners that they typically would not have been able to access on their own. REITs typically have a favorable capital structure because of their access to corporate-level debt and equity, and are able to use this capital to finance tenant improvement costs and leasing commissions that less well capitalized owners would not be able to afford.

### SUMMARY

A method for leveraging certain business entities as real estate investment trusts may be disclosed. Such a method may include creating at least one operating partnership associated with a REIT; placing at least one business entity into the at least one operating partnership; transferring a plurality of operating partnership units associated with the at least one operating partnership to the owner of the at least one business entity; engaging in a transaction whereby a plurality of operating partnership units associated with the at least one operating partnership are exchanged for a plurality of shares in the REIT; and selling a plurality of the exchanged plurality of the shares in the REIT to the public.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

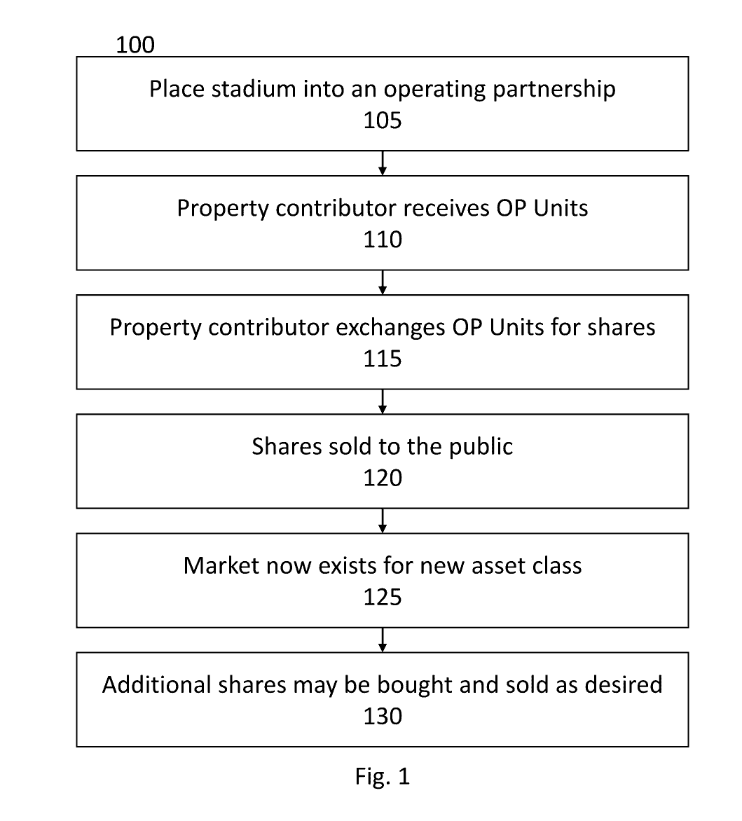

Exemplary FIG. 1 shows a process flow diagram for an exemplary embodiment of a method of leveraging certain business entities as real estate investment trusts (REITs).

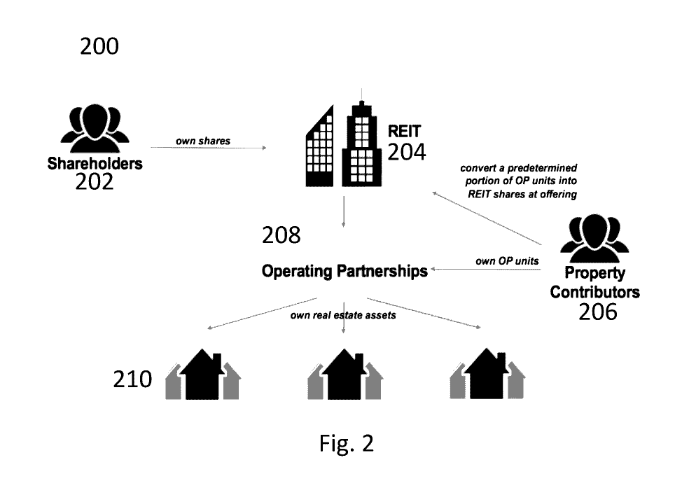

Exemplary FIG. 2 shows a process flow diagram for an exemplary embodiment of a method of leveraging certain business entities as real estate investment trusts (REITs).

### DETAILED DESCRIPTION OF THE EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiment may be described herein as, for example, “a computer configured to” perform the described action.

Generally, a method of leveraging certain business entities as real estate investment trusts (REITs) may be disclosed. Exemplary embodiments of this invention may be directed toward specific business entities or specific properties, such as, for example, stadiums, arenas, convention centers, theaters, ballparks, rinks, or other venues in which to watch or hear live entertainment, as desired.

This may be advantageous for a number of reasons. First, at present, the vast majority of stadiums, arenas, convention centers, or other such properties are currently owned exclusively by either private investment firms or relatively small and highly concentrated groups of wealthy individuals. This lack of potential owners creates problems in the real estate industry; for example, often stadium owners are unable to sell their stake in a stadium, or other large facility, without offering a substantial discount in price in order to entice potential new buyers, because of the lack of selling options stadium owners face.

Stadiums and other such properties may also often require repairs and other forms of maintenance. In many cases, owners of these properties may not be able to provide necessary repairs for lack of funding, because the stadium or other property (which may subsequently be referred to as a “stadium”) may be the largest asset that the owner possesses. Hence, an owner may be unable to raise enough money for repairs without an outright sale or large partial sale of the asset to an outside investor. These full or large partial sales, as previously elaborated, may require the owner to sell a stake in the asset at a significant discount to true value due to the owner's lack of exit options (liquidity options).

As such, it may thus be desirable to enable an owner to sell only fractional portions of a property in the public market, which may enable them to receive fair market value. Doing so would provide additional liquidity options to stadium owners; instead of having to make a full or large partial sale of their asset to an outside investor in order to raise capital, they can sell off fractional portions at fair market value, for example to public retail investors. This may give stadium owners and future purchasers greater flexibility in monetizing their asset.

For example, a current stadium owner may be interested in selling his position in a stadium, but may find himself unable to divest it to a prospective purchaser for his asking price because potential purchasers, such as wealthy individuals and private investment firms, know that they are the only source of exit opportunities for current owners. This may create a market where future purchasers demand large discounts to relieve current owners of their ownership position and force sellers to settle for below economic sale prices in order to complete their transactions; this may be undesirable for the seller. However, as an alternative to seeking out a purchaser, current owners may be able to take their ownership interest in stadiums and exchange it for operating units that are convertible into the publicly traded stock of a REIT. This allows for stadium owners to no longer be dependent upon wealthy individuals and private investment firms for their exits. It also simultaneously allows for the public retail investor to gain a new set of investment opportunities not previously available to them. The REIT method would allow the owner of a stadium an easy “exit strategy” for ownership of the property, should they decide that they no longer wish to be the owner or majority owner; instead of having to find a prospective buyer for the entire asset, and potentially having to sell the asset at substantially less than fair-market value, they may instead sell off fractional portions of the property piece-by-piece to a diversified group of public stock investors. This piece-by-piece selling method may also create significantly fewer transaction costs than those associated with an entire asset sale.

Enabling the trade of shares in a stadium property by employing a REIT would also allow the general public to benefit from being able to invest in a particular real estate asset class that was not previously available to them to invest in, such as stadiums and convention centers. Currently, the ability to own and profit from stadium ownership is a luxury only reserved for the ultra-wealthy. However, enabling the trade of shares in a stadium property by employing a REIT may serve as the basis for a new type of financial security, a publicly traded equity interest in stadiums, which would allow a the public retail investor to participate in the financial benefits of stadium ownership.

The apparent lack of similar REITs on the market may also make such securities popular with those investors trying to maintain a diverse portfolio. It is worth noting that as of Sep. 30, 2015 the total Equity Market Cap of the REIT industry had reached $890 B; however, of the 223 REITs that comprised this overall Market Cap, not a single one incorporated a stadium real estate asset or a similar real estate asset within it. As such, it may be desirable for investors to specifically invest in stadium or other entertainment venue REITs alongside other kinds of REITs for much the same reason an investor might invest in entertainment company stocks alongside the remainder of their stock portfolio.

This newly formed financial security may also result in significantly better price discovery of a stadium's day-to-day valuation, providing additional benefits to the holder of a stadium property above and beyond those already described. Stadiums and other large venues are generally infrequently traded, and as a result mostly receive speculative pricing that could be radically different from a stadium's actual fair market value. However, according to the efficient-market hypothesis, the value of any publicly-traded asset will tend to come to reflect the proper fair market value of that asset; as such, subjecting shares of the stadium to public trading may cause the pricing of the stadium to become less speculative.

Enabling the trade of shares in a stadium property by employing a REIT may also have further benefits for the owners of the stadium property. The REIT method allows for stadium operators and building managers, working to maintain the stadium, to receive some of their compensation in the form of an equity interest in the asset/stadium they manage. This may function similarly to an employee stock option plan, or to a scheme in which a CEO of a firm is compensated in his company's own stock. This would provide a strong alignment of interest to all of those operating these expensive pieces of real estate, as it allows managers to directly benefit from the fruits of their labor, since the equity interest they hold would appreciate if the stadium is diligently managed. This may provide added motivation to those individuals, ensuring that they see it as being to their personal benefit to try to increase the value of their shares to the greatest extent possible.

Finally, creating a REIT structure for a stadium or other large venue may be more tax-efficient for the current owners and for future public shareholders.

Turning now to the drawings, exemplary FIG. 1 depicts a process flow diagram 100 for a method of leveraging certain business entities as real estate investment trusts (REITs), or specific subcategories of REITs such as umbrella partnership real estate investment trusts (UPREITs). First, as illustrated in FIG. 1, a stadium, or other such property, may be placed into an operating partnership 105. This may be either an existing operating partnership or a newly-created operating partnership, as desired. According to an exemplary embodiment, an operating partnership may be a form of limited partnership that includes a number of operating partnership units (“OP units”) that may be convertible to common shares. These OP units may be interchangeable with assets of the REIT, such as real estate; a property owner may contribute an owned property to the REIT in exchange for a certain number of OP units. Such properties may include, for example, properties which, if sold, would generate income tax liabilities that exceed net proceeds from sale; properties that are fully or substantially depreciated; properties with maturing indebtedness; properties with high loan to value ratios; properties with debt that is personally guaranteed or recourse to general partners; or any combination of the above or any other property. According to an exemplary embodiment, OP units may be classified as a security and may earn dividends.

The owner of the stadium or other property that was placed into the operating partnership 105 may then receive a number of OP units 110 corresponding to their property contribution. The property owner may be able to exchange some or all of these OP units for shares 115, as desired. According to an exemplary embodiment, a fixed, predetermined number of OP units may be converted into shares, which may represent some minimum commitment of each property owner involved in the REIT; if only one property owner, such as the property owner of a single stadium, is involved in the REIT, then only that property owner may be required to make such a commitment.

These shares may then be sold to the public in an initial public offering 120. This may serve to create a market for the new asset class 125, allowing the owners of stadiums and other properties to sell (or buy back) portions of their ownership in a form that was not previously available to them, should they wish to do so. This may also allow the public to buy and sell assets in a new asset class that was not previously available to them, this being the asset of partial ownership of a stadium or other such property. All parties may continue to buy and sell additional shares 130, as desired; for example, according to an exemplary embodiment, more OP units owned by the original property owner may be converted into shares and sold to the public at a later time.

Turning now to exemplary FIG. 2, FIG. 2 depicts an alternative process flow diagram 200 for a method of leveraging certain business entities as real estate investment trusts (REITs). According to an exemplary embodiment, shareholders 202 including property contributors 206 may own shares of a particular REIT 204, this REIT comprising a plurality of operating partnerships 208 that own real estate assets 210. Property owners 206 may contribute property to the operating partnerships 208, and may in return receive a number of OP units reflecting the real estate assets 210 that they have contributed to the operating partnerships 208. Property owners 206 may then be able to convert a predetermined portion of their OP units into shares in an REIT 204; they may then sell some or all of these shares to members of the public 202.

A potential problem, however, is that it may be difficult to calculate or estimate a fair value for any business entity to be exchanged for a plurality of shares or operating partnership units. It may, however, be necessary to do this, for example if multiple business entities are incorporated into the same REIT and are valued differently. For example, if the fair value of the business entity, in shares or operating partnership units, is based on its expected sale price, owners of business entities might not be eager to make use of the system, as the expected sale price might be very low. However, if the fair value of the business entity, in shares or operating partnership units, is based on factors like the purchase value of the business entity, its construction value, its real estate value, or its income, expenses, assets and/or liabilities, the owner of a business entity might be compensated for a higher value in shares or operating partnership units than they could expect to get by selling the business entity, and as such the owner of the business entity might be unjustly compensated at the expense of the other participants in the REIT.

As such, it may be necessary to determine the value of every business entity to be contributed to the REIT using a consistent methodology. For example, a computer may be configured to accept user input regarding a business entity to be placed into an operating partnership by an owner of the business entity; determine, using a probabilistic model based on the current and projected assets and liabilities of the business entity, a present value of the business entity to the operating partnership; determine, based on the present value of the business entity to the operating partnership and the present value of the operating partnership, a number of operating partnership units that reflect the business entity contribution to the operating partnership; and award said number of operating partnership units to the owner of the business entity. Other factors, such as the purchase value of the business entity, the expected sale value of the business entity, its construction value, its real estate value, or its income, expenses, assets and/or liabilities may also be incorporated into the probabilistic model, as desired.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method for leveraging certain business entities as real estate investment trusts, comprising:
creating at least one operating partnership associated with a REIT;
placing at least one business entity into the at least one operating partnership;
using a probabilistic model based on the current and projected assets and liabilities of the business entity to determine a present value of the business entity to the operating partnership;
determining a number of operating partnership units that reflect the at least one business entity contribution to the operating partnership by comparing the present value of the business entity to a present value of the operating partnership calculated using the same probabilistic model when the operating partnership has other value;
transferring the number of operating partnership units associated with the at least one operating partnership to the owner of the at least one business entity;
engaging in a transaction whereby a plurality of operating partnership units associated with the at least one operating partnership are exchanged for a plurality of shares in the REIT; and
selling a plurality of the exchanged plurality of the shares in the REIT to the public.

2. The method of claim 1, wherein the at least one business entity is a stadium.

3. The method of claim 1, wherein the at least one business entity is an arena.

4. The method of claim 1, wherein the at least one business entity is a convention center.

5. The method of claim 1, wherein the at least one business entity is a theater.

6. The method of claim 1, wherein the at least one business entity is a ballpark.

7. The method of claim 1, wherein the at least one business entity is a rink.

8. The method of claim 1, wherein the at least one business entity is a venue used to host live entertainment.

9. The method of claim 1, wherein the plurality of the exchanged plurality of the shares in the REIT is sold to the public by initial public offering.

10. The method of claim 1, wherein the REIT is newly created.

11. The method of claim 1, wherein the REIT is an existing REIT having one or more other business entities already existing within the operating partnership.

12. The method of claim 1, wherein a plurality of shares in the REIT are provided as equity compensation to an employee of the at least one business entity.

13. The method of claim 1, wherein operating partnership units associated with the at least one operating partnership are convertible into shares of the REIT.

14. A system of leveraging certain business entities as real estate investment trusts, comprising at least one processor and at least one memory module including computer program code, the at least one memory module and the computer program code configured to, with the processor, cause the system to at least:
accept user input regarding a business entity to be placed into an operating partnership by an owner of the business entity;
determine, using a probabilistic model based on the current and projected assets and liabilities of the business entity, a present value of the business entity to the operating partnership;
determine, based on the present value of the business entity to the operating partnership and a present value of the operating partnership calculated using the same model, a number of operating partnership units that reflect the business entity contribution to the operating partnership; and
award said number of operating partnership units to the owner of the business entity.
